(19) United States
(12) Patent Application Publication
(10) Pub. No.: US 2018/0126725 A1
(43) Pub. Date: May 10, 2018

(54) DEVICE FOR CODING PRINTING SHEETS IN A SHEET-FED PRESS

(71) Applicant: manroland sheetfed GmbH, Offenbach (DE)

(72) Inventors: Olga MARTIN, Obertshausen (DE); Holger WIESE, Obertshausen (DE); Hans-Bernd JÄGER, Eichenzell (DE); Edgar WERBER, Offenbach (DE); Christian SCHLEGEL, Dietzenbach (DE)

(21) Appl. No.: 15/516,331

(22) PCT Filed: Sep. 30, 2015
(86) PCT No.: PCT/EP2015/072605

§ 371 Date: Nov. 2, 2017

(30) Foreign Application Priority Data
Oct. 2, 2014 (DE) 10 2014 114 387.6
Sep. 23, 2015 (DE) 10 2015 116 030.7

(51) Int. Cl. B41F 19/00; B41J 2/44; B41J 2/01; B65H 11/00; B65H 5/24; B65H 7/20

(52) U.S. Cl. CPC B41F 19/007; B41J 2/442; B41J 2/01; B65H 11/00; B65H 2513/50; B65H 5/24; B65H 7/20; B65H 2511/11; B65H 11/002

(57) ABSTRACT

The invention relates to a sheet-fed press (10) comprising a sheet feeding device (11) for introducing sheets that are to be printed into the sheet-fed press, at least one printing unit (12) and/or coating unit (13) for printing the sheets with a static printed image that is identical for all sheets, a discharging mechanism (14) for discharging printed sheets from the sheet-fed press, and at least one printing device (1) which includes no printing form and is integrated into the sheet-fed press (10) to print the sheets with an especially dynamic, variable printed image. According to the invention, the printing device (1) is integrated in the region of a supply strip (19) in the sheet-fed press (10) which guides a stream of products to the first of the printing units (12).

### TECHNICAL FIELD OF THE INVENTION

The invention concerns a device for coding in a sheet-fed press.

### BACKGROUND OF THE INVENTION

Printing devices without a printing form, which preferably serve to customize printed products produced via offset printing with barcodes, numbering or other types of marking, for example, are increasingly being used in sheet-fed presses that operate according to the offset printing principle. Such form-free printing devices are also referred to as non-impact print (NIP) printing devices and can be configured as inkjet printing devices, for example, that have at least one inkjet printhead, wherein the or every inkjet printhead can function according to the so-called continuous inkjet principle, the drop-on-demand inkjet principle, the thermal inkjet principle, or any other inkjet principle. The printing form-free printing devices or NIP printing devices can also be designed as laser printing devices.

A sheet-fed press, in which a printing form-free printing device configured as an inkjet printing device or a laser printing device is integrated into an offset printing unit of the sheet-fed press, is known from DE 197 04 003 A1. The printing form-free printing device is disposed across from a sheet-guiding impression cylinder in the area behind the passage of sheets through a nip formed by the impression cylinder and a blanket cylinder. With the printing press according to DE 197 04 003 A1, the printing of sheets with high stiffness in the area of the inkjet printing device or the laser printing device, in particular, is difficult.

The reason for this is that, after leaving the nip, such sheets tend to spring up in the area of the trailing edge of the sheets, abruptly changing the distance between the printing form-free printing device and the sheets, which is why, without appropriate guide elements, the sheets can hit against the form-free printing device, so that the sheets cannot be printed with the same quality in the area of the trailing edge of the sheets as in the area of a leading edge of the sheets and/or a central area of the sheets.

For immobilizing the sheets on the surface of the impression cylinder, DE 197 04 003 A1 proposes sheet guide rollers. These rollers cover areas of the sheets, however, which is why the sheets in the printing press according to DE 197 04 003 A1 cannot be printed across the entire format width by the form-free printing device. The arrangement of the form-free printing device in the area of the nip furthermore implies that impressions are made in the freshly printed sheets by the form-free printing device, creating the risk that the used sheet guide rollers leave marks on the surface of the sheets, thus compromising the achievable print quality.

Another sheet-fed press with an integrated form-free printing device is known from DE 195 14 259 A1, wherein, according to this state of the art, viewed in the transport direction of the sheets, the form-free printing device is integrated into said sheet-fed press behind the last offset printing unit, as well as, viewed in the transport direction of the sheets, in front of a discharging mechanism of the sheet-fed press.

A sheet-fed press is also known from DE 10 2006 002 302 A1. The sheet-fed press is equipped with a sheet feeder for the delivery of sheets, and one or more printing units for printing the sheets with a static printed image that is identical for all sheets. At least one form-free printing device for printing the sheets with a printed image that varies from sheet to sheet is further integrated into the sheet-fed press. This one or every one of these form-free printing devices is integrated into the sheet-fed press in the area of the sheet feeder. In the case of use of a single sheet feeder, a sheet on a feed table can be printed across its entire area. Further provided are sensors, which detect the front edge and the side edge of the sheet. The position of the sheet is thus defined and a static printing or a printing that varies from sheet to sheet, which is targeted in terms of the positioning of the printing patterns, with the form-free printing device, can be made possible.

An installation position above a feedboard disposed in front of the sheet alignment system in a sheet feeder configured as a stream feeder is preferred. In addition, an installation position above a conveyor table, which in delivery direction is upstream of the feedboard and serves the sheet feeding device in a sheet feeder configured as a single-sheet feeder, is preferred.

A sheet-fed press with a feeder, at least one printing and/or coating unit for printing a static printed image that is identical for all sheets, with a discharging mechanism and at least one form-free printing device integrated into the sheet-fed press for printing a printed image that varies from sheet to sheet is known from DE 10 2009 000 523 A1. The form-free printing device is disposed in the area of sheet-guiding cylinders, wherein, for reliable guidance of the sheets in the area of the printing devices, the sheet-guiding cylinders are provided with devices to hold the sheets in place for flat level guidance of the sheets.

The printing of addresses or the like on newspapers is known from DE-PS 895 157. To print addresses on newspapers, the newspapers are moved in a conveyor in an overlapping stream, i.e. shifted relative to one another. The newspapers lie on top of one another in a scale-like manner, so that only as much of the edges of the copies is exposed as corresponds to the print area required by the address. Printing is performed with the aid of a text strip made of plastic, rubber, textile fabric, paper or metal.

### BRIEF SUMMARY OF THE INVENTION

In view of the foregoing, an object of the present invention is to provide a novel device for the simple, flexible and secure coding of sheets in a sheet-fed press.

According to the invention, a printing device without a printing form is integrated into the area of the sheet feeder in the sheet-fed press in such a way that every sheet can be coded in a selectable range from an upper side.

According to the invention, each form-free printing device is integrated into the area of the sheet feeder in the sheet-fed press in such a way that every sheet can be coded in a selectable range from an underside.

According to the invention, each form-free printing device is integrated into the area of the sheet feeder in the sheet-fed press in such a way that every sheet can be coded in a selectable range, wherein, in conjunction with sensors, a control system detects the presence of sheets and controls the time to start a coding or a numbering. According to the invention, the coding or numbering is manually or automatically activated for production, wherein the printing with a form-free printing device is subsequently enabled only after a sensor has signaled the presence of sheets in the print area and/or the presence of correctly colored sheets in the print area. Another sensor must also have signaled a zero position or a starting time for the passage of each of the sheets that is adjustable as a function of the length of the print format.

In accordance with the present invention, it is proposed that each form-free printing device in the area of the sheet feeder of the sheet-fed press be integrated into the sheet feeder. Therefore, in accordance with the present invention, the printing of sheets with the aid of each form-free printing device is performed at a time that is prior to the printing of the sheets in the printing units of the sheet-fed press preferably configured as offset printing units. Since the sheets that are to be printed run, or are aligned to be, flat in the area of the sheet feeder and not curved as in the area of the printing units of the sheet-fed press, the form-free printing devices can be disposed at a small distance to the sheets. This eliminates the need for rolling sheet guide rollers on the side of the sheets to be printed, which on the one hand compromise the print quality and, on the other hand, limit the printable width of the sheets in the area of each device without a printing form.

An inventive method for introducing sheets into a sheet-fed press uses one or more form-free printing devices in conjunction with a stream feeder processing a shingled stream of sheets on a conveyor table. Once the printing devices are assigned to the sheets on the conveyor table in a printing position, wherein they can be assigned to the rear ends of the sheets exposed in the shingled stream from above or to the front ends of the sheets exposed from below in the shingled stream from below, the printing devices are manually or automatically activated for production.

Printing by means of the printing device is enabled when a sensor signals the presence of sheets and/or the presence of correctly colored sheets in the print area, and when the sensor signals a zero position or a starting time for the passage of each of the sheets that is a function of the length of the print format.

In a further development, at least one characteristic curve, which is a function of the parameters of the printing substrate, such as sheet format, sheet thickness, grammage, fiber direction and/or stiffness of the sheets, is stored in a control system of the form-free printing device. The form-free printing device can be controlled on the basis of this characteristic curve and a data connection of the control system is provided to input order data from a controller of the sheet-fed press.

In a further development, each form-free printing device can be configured as an inkjet printhead or a laser printing device, which are arranged to print the sheets in the shingled stream across the entire exposed format width and/or exposed format length of the upward facing surface.

In a further development, every inkjet printhead or laser printing device can be arranged to print the sheets in the shingled stream across the entire exposed format width and/or exposed format length, wherein the inkjet printheads or the laser printing devices are assigned to one or more at least partial areas of openings in the conveyor table that expose the underside of the sheets resting on the conveyor table.

In a further development, several inkjet printheads or laser printheads can be provided, which are interconnected on the control side and arranged side by side viewed transverse to the transport direction of the sheets, and/or arranged in a row viewed in the transport direction of the sheets.

In a further development, printing devices can be removed from the sheet-fed press and can be used on another sheet-fed press or at a variety of installation positions within the same sheet-fed press.

In a further development, viewed in the transport direction of the sheets, a drying device and/or a suction device can be disposed downstream of the form-free printing devices.

In a further development, form-free printing devices in the area of the sheet feeder can be arranged in a pivotable manner with respect to the conveyor table.

Preferred further developments of the invention arise from the following description. Design examples of the invention are explained in more detail by means of the drawings without being restricted thereto.

### BRIEF DESCRIPTION OF THE DRAWINGS

FIG. 1 is a schematic, partially cut away side view of an exemplary sheet-fed press with a variety of devices according to the invention.

FIG. 2 is an enlarged, schematic view of a portion of the sheet-fed press of FIG. 1 showing a device for coding printing sheets according to the invention.

FIG. 3 is an enlarged, schematic view of a portion of the sheet-fed press of FIG. 1 providing a more detailed schematic representation of the device for coding printing sheets according to FIG. 2.

FIG. 4 is a schematic circuit diagram of the device for coding printing sheets according to FIGS. 2 and 3.

### DETAILED DESCRIPTION OF THE INVENTION

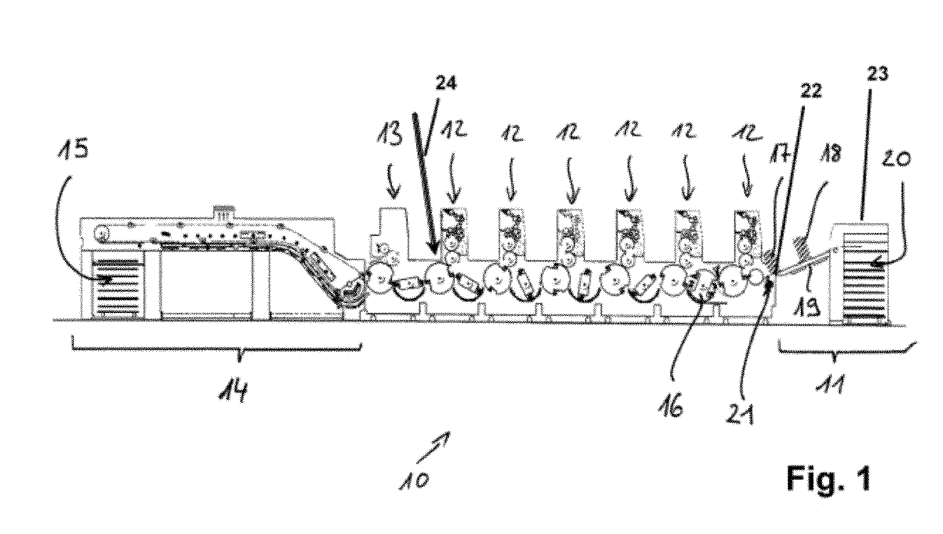

FIG. 1 shows a schematic representation of a sheet-fed press 10 according to the invention, wherein the sheet-fed press 10 comprises a sheet feeding device 11, several printing units 12 that are configured as offset printing units, a coating unit 13 downstream of the printing units 12 and a discharging mechanism 14 downstream of the coating unit 13. The sheet feeding device 11 serves to introduce sheets that are to be printed into the first of the printing units 12 of the sheet-fed press 10, and comprises a sheet feeder 20 with a feeder stack and a sheet singling device 23, a conveyor table 19 and a feedboard 22 in conjunction with a pre-gripper 21. The sheets are moved through the printing units 12 and the coating unit 13 and printed there with a printed image that is the same, i.e. unchanging, for all the sheets and is thus static. In the area of the discharging mechanism 14, printed sheets are discharged from the sheet-fed press creating a discharger stack 15. In the design example shown in FIG. 1, the sheet-fed press 10 according to the invention is configured as a so-called perfector that serves for printing on both sides of the sheets in what is referred to as perfecting. For this purpose a transfer cylinder disposed between the first two printing units 12 is configured as a turning cylinder 16.

At least one printing device without a printing form, which preferably serves for printing the sheets with a static printed image or with a printed image that varies from sheet to sheet, is integrated into the inventive sheet-fed press 10. In the sense of the present invention, each form-free printing device is integrated into the sheet-fed press 10 in the area of the sheet feeder 11, wherein possible mounting positions 17 and 18 for each form-free printing device are shown schematically in FIG. 1. In both installation positions 17 and 18, the sheets are printed from above in the area of the sheet feeder 11 via each form-free printing device.

When the sheets are transported along the conveyor table 19, the sheets are aligned to be level and flat. A small distance can be maintained between each form-free printing device and the sheets, thus providing high print quality.

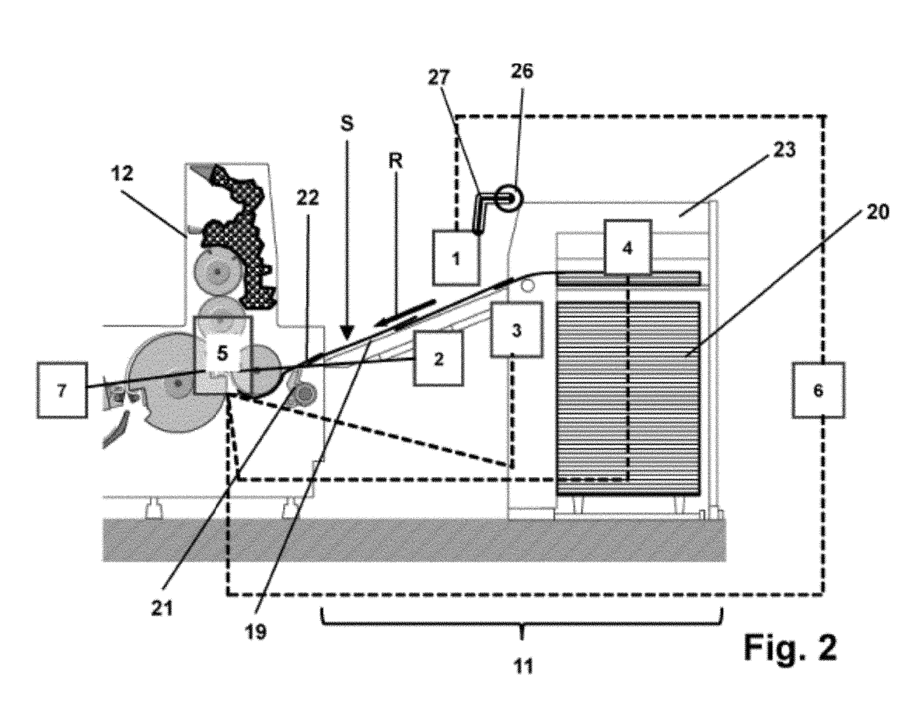

The sheet feeder 11 is configured as a so-called stream feeder for conveying a shingled stream S of sheets in the sheet running direction R across the conveyor table 19. In this case, the installation position 17 for the printing device can be selected above a feedboard 22 of the sheet-fed press 10 symbolically illustrated in FIGS. 1 and 2 at the first of the printing units 12. In the area of the feedboard 22, the last sheet of the shingled stream S is present individually, is aligned with the front and lateral edge, grabbed by a so-called pre-gripper 21 and delivered to the first of the printing units 12 of the sheet-fed press 10. Since, in this case, the surfaces of the sheets are completely freely accessible, they can be printed by the form-free printing device with a static printed image or with a printed image that varies from sheet to sheet across the entire format width and format length.

As a result of the sheet alignment and sheet guide mechanisms present there, however, the installation position 17 is cramped. In addition, the respective first sheet is accelerated there by the pre-gripper 21 from the speed on the conveyor table to the machine speed of the printing unit 1. This makes complex measures for integration necessary here.

For easy integration and adaptation to the production needs, in a sheet feeder 11 configured as a stream feeder, a form-free printing device is inventively integrated into the sheet feeder 11 in installation position 18 above the conveyor table 19.

FIG. 2 shows an overview of the arrangement according to the invention. It shows the integration of a form-free printing device configured as an inkjet printhead 1 in the area of a conveyor table 19 configured as a suction belt table. The selected embodiment relies on the fact that, due to the underlapping of the sheets in the shingled stream S, the sheet end or the rear shingle length of every sheet is always visible from above, and therefore also printable, regardless of the format length of the sheets on the conveyor table 19. An appropriate control of the inkjet printhead 1, which is performed by means of a controller 6, is therefore necessary. A printhead mounting above the conveyor table 19 is further required for the inkjet printhead 1. This mounting can be configured to be static, movable or pivotable, so that the inkjet printhead 1 can be positioned as needed for production purposes and can be moved out of the working area for set-up and maintenance purposes.

A product sensor 2 for detecting the presence of sheets on the conveyor table 19 can be disposed on a holding device (for mounting the sensor 2 above or below the conveying surface of the conveyor table 19). The sensor 2 may be in the form of a reflected light sensor, a laser sensor, a color sensor or another sensor that detects a printing substrate.

A rotary encoder 3, which may comprise a measuring wheel with rubber studs, is provided to detect the functional position of the sheets on the conveyor table 19, so that the forward movement of the sheets in the shingled stream S can be identified and analyzed as needed.

For the definition of the printing operation by the inkjet printhead 1, a sensor 4 to initiate printing is provided as well. In FIG. 2, this sensor is assigned to the sheet singling device 23 (also referred to as suction head) in the sheet feeder 20 above the feeder stack. The sensor 4 is connected to one or more elements of the sheet singling device 23 and/or the sheet delivery over the conveyor table 19.

For the circuitry-related connection between the sensor 4 and the control systems, an input/output connection element is provided for installation, for example, in a control cabinet of the first of the printing units 12.

In this context, a printhead controller 6 with a device holder for operable positioning is arranged in the area of the sheet feeding device 11. This can preferably occur in the area of operating devices of the sheet-fed press 10/the sheet feeder 20, which are often provided parallel to the conveyor table 19.

A control system 7, for operating the form-free printing device from an operating position on the discharging mechanism 14 of the sheet-fed press 10, with a switch to start the inkjet printhead 1 and a control diode to display the activity or the operational readiness of the inkjet printhead 1, can be provided as well.

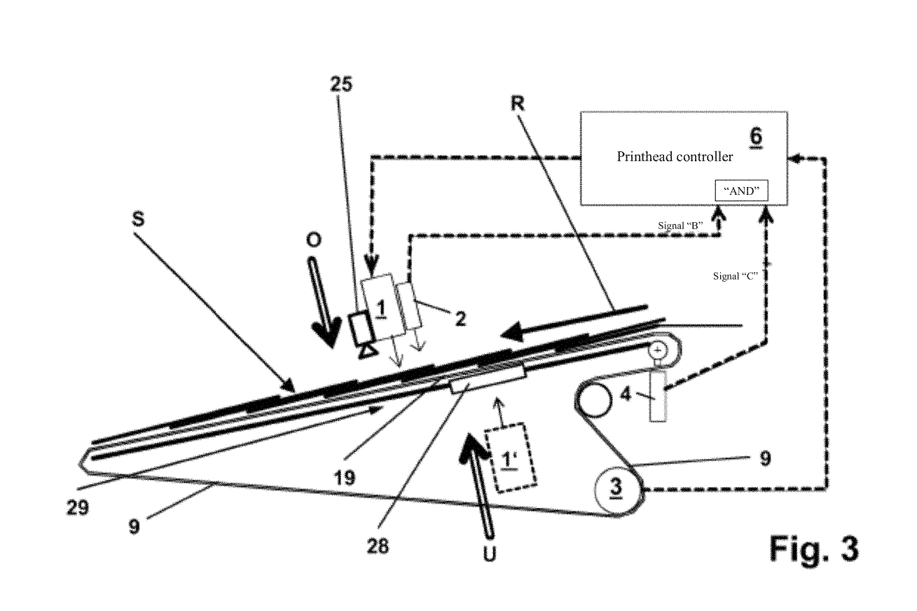

FIG. 3 shows the functionality of the inkjet printhead 1 in conjunction with the sheet feeding device 11 in greater detail.

Should consecutive numbering or sheet-related individual coding of sheets be desired, this can be performed in a variety of operations. The start of sheet numbering or coding can be initiated by a so-called good-sheet counter or by means of another appropriate signal. Programming can also be performed through specifications when setting up the sheet fed press 10. The numbering or coding can be set via the function of a sheet inspection device 24 with reference to the printed sheet. The sequential number can be inserted into the inspection result in the log of the sheet inspection device 24.

For the implementation according to FIG. 3 the following form-free printing device arrangement is provided in conjunction with the sheet feeder 20, the sheet-singling device 23 (both of which are not shown in FIG. 3), but at least with the conveyor table 19. In particular, an inkjet printhead 1 is provided in a centrally extending area above the conveyor table 19. The inkjet printhead 1 is directed approximately towards the central area of the underlapping sheets of the sheet stream S.

The requirement is that, regardless of the format length of the sheets on the conveyor table 19, the rear end of every sheet in the shingled stream S is always visible from above and can therefore also be printed in any area of the shingled stream.

The processability of all print formats is thus made possible, because the processable format lengths of sheets in a single sheet-fed press may, for example, lie between the values of 340 mm and 740 mm.

Printing with the inkjet printhead 1 must be initiated automatically and all sheets in the shingled stream S must be printed, regardless of their format length. Manual intervention by the printer must be avoided.

The synchronization of the numbering or coding is then performed with equipment that described below.

A sensor 2 is disposed in the area of the inkjet printhead 1 above the conveyor table 19 (or also below, under a control opening in the conveyor table 19), and monitors whether a sheet is present under the inkjet printhead 1. If this is the case, the sensor 2 emits a “sheet” signal. The sensor 2 can be a simple optical reflex sensor, a laser sensor, a color sensor, or another sensor for detecting a printing substrate, which is disposed above the conveyor table 19 and arranged to scan the surface of the conveyor table 19, and to which an opening in the conveyor table 19 or a dark area on the conveyor table 19 is assigned.

The sensor 2 is needed in all modes of operation, manual or automatic.

Using a machine angle known from the machine control system and a so-called application point adjustment of the sheet feeder 20 or the sheet singling device 23, the print start for the inkjet printhead 1 is calculated as a function of the format (as appropriate to the used format length) and a corresponding control signal is sent to the inkjet printhead 1 via a printhead controller 6. The precision of the print position is estimated in the circumferential and lateral direction at approximately+/−3 mm.

A wheel pulse transmitter configured as a rotary encoder 3 is assigned to a conveyor belt 9 of the conveyor table 19 under the conveyor table 19. The rotary encoder 3 emits equidistant pulses with respect to the transport path of the conveyor belt 9 (for example, 300 dpi=84 μm steps). In doing so, a speed modulation of the sheet transport from 32% to 168% (referred to as a so-called sheet deceleration) per stream path is detected at the same time and likewise passed on to the inkjet printhead 1, so that it is automatically taken into account.

The inkjet printhead 1 is mounted on a cross member 26 that is present in the sheet feeder 20 or is disposed above the conveyor table 19, and can be positioned along the length and transverse to the shingled stream S. In sheet transport direction R, however, the position can be unchangeable.

The zero positioning of each of the sheets coming in on the conveyor table 19 is reported by a sensor 4, which in this case is assigned to a drive element of a conveyor belt 9 of the conveyor table 19. The sensor 4 can, however, also be assigned to the sheet feeder 20 and in particular to the sheet singling device 23.

During operation, the inkjet printhead 1 is controlled by a combination of the signals of sensors 2 and 4. Numbering or coding on the exposed end of a sheet is therefore performed when sensor 2 signals the presence of a sheet and when sensor 4 emits the zero position signal for the sheet transport. The zero position signal is a function of the format length of the sheet and is adjusted to this format length when setting up a printing order. This configuration can be performed automatically based on the known format lengths in the sheet-fed press 10.

Since underlapping in a sheet-fed press 10 is fixed with respect to its length, multiple overlapping of sheets occurs when a specific larger format length is exceeded. Duplicate numbering or coding of the first sheet must then be avoided. This can be accomplished with metrological means or with appropriate configurations when setting up the sheet-fed press 10.

If so-called make-ready sheets are used to set up a printing order, in addition to numbering or coding, a distinction should be made between make-ready sheets and print sheets as overlay sheets. The make-ready sheets can be counted, but not printed with a numbering/coding. The overlay sheets, however, maybe for documentation, are labeled with a numbering/coding, such as the order number and a date.

Counter readings must be displayed for make-ready and overlay sheets as well. The overlay sheets can furthermore be counted and marked with a stripe every 500 sheets.

A color sensor for detecting a differently colored make-ready sheet can therefore be used as an alternative to sensor 2 that is configured as a product sensor.

A function for defining a plurality of characteristics that are linked to the output signal of the color sensor can furthermore be specified. It is therefore possible that, for a white printing substrate, the corresponding sheet could be numbered/coded, while for a colored, e.g. red, printing substrate, a non-printing counter could be recorded. Both counters are displayed at the printhead controller 6.

Concerning the dependence of the format length, the following description is an example for a particular sheet-fed press 10:

At a format length up to 568 mm, a sheet is always printed once. Beyond a sheet length of 568 mm, an additional sensor can be used to avoid labeling the first sheet twice. In such a case, a manual pre-selection is possible as well. To remain flexible, however, an additional sensor should be installed that is activated at format lengths greater than 568 mm length. Duplicate labeling of the first sheet must be avoided.

If an inkjet printhead 1 is provided with a cartridge system for ink supply, the embodiment offers the user the benefits of very easy handling, with easily replaceable and interchangeable cartridges and minimum cleaning effort, because the cartridges can be cleaned very easily and quickly.

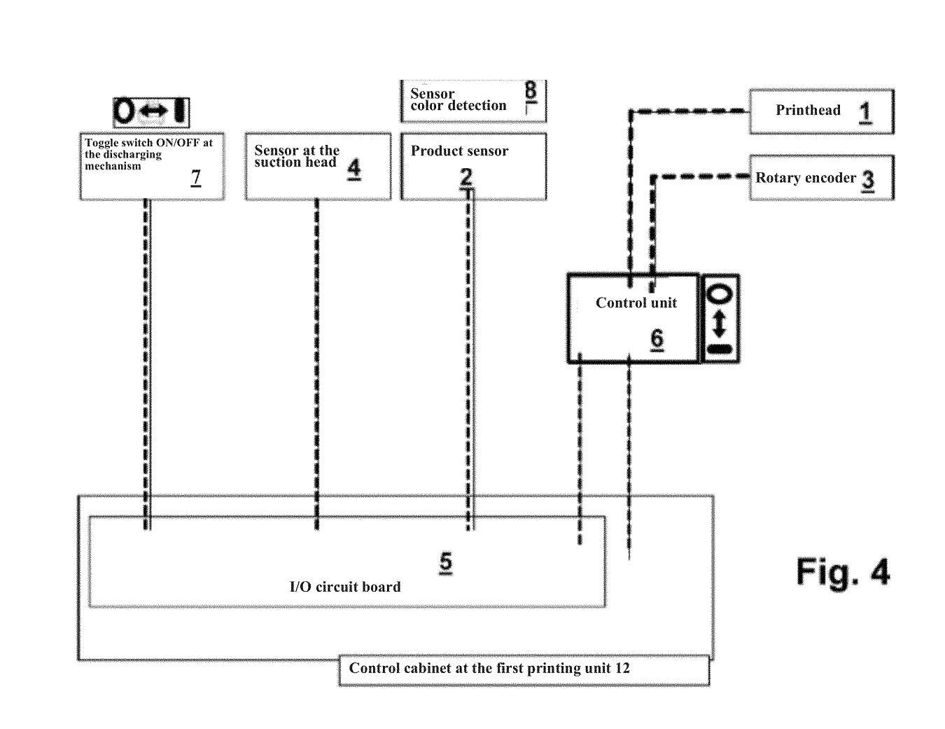

FIG. 4 shows the circuitry of the form-free printing device. The inkjet printhead 1 is coupled to a control unit (printhead controller) 6, from which all control signals regarding on/off, time, duration and printing patterns are sent to the inkjet printhead 1.

The control unit 6 is also provided with input/output devices. The printing operation can be enabled or disabled with the input/output devices via control unit 6.

Output data regarding the printing operation, such as counter readings, can furthermore be displayed at the control unit 6.

The control unit 6 is further assigned to the rotary encoder 3, which determines the conveying speed of the shingled stream S or of the individual sheets on the conveyor table 19, based on the speed of the conveyor belt(s) 9. This data is used to establish the synchronization of the printing operation of the inkjet printhead 1 with the speed of the sheets on the conveyor table 19.

The control unit 6 is connected to the control cabinet of the first of the printing units 12, e.g. for power supply and for the control-related coupling with the machine control. Enabling and disabling the inkjet printhead 1 in the printing process can thus also be performed via the machine control of the sheet-fed press 10. The data output for logging the printing process at the inkjet printhead 1 can furthermore also take place via a control center of the sheet-fed press 10. In this way, print contents of the inkjet printhead 1, counter readings regarding the sheets to be processed or information regarding the process status can be transferred from the control unit 6 to the machine control for display at the control center, or also for further processing.

An input/output device, such as circuit board 5, is additionally disposed in this control cabinet to which the other control systems are connected.

The sensor 2 is connected to the input/output circuit board 5 first, as a product sensor for the presence of sheets.

Next, the sensor 8 is connected to the input/output circuit board 5 for color detection of the sheets that are currently in place.

Sensor 4 can also be connected to the input/output circuit board 5 for the purpose of activating the printing process at the inkjet printhead 1, by emitting zero or start signals or detecting the stream position of the shingled stream S of sheets moving across the conveyor table 19. The sensor 4 is referred to here as the sensor on the suction head, wherein, as previously explained, it may also be connected to and act in concert with sheet conveyors such as the conveyor table 19.

Finally, an on/off switch 7 for operation of the inkjet printhead 1 from the location of the discharging mechanism 14 is connected to the input/output circuit board 5.

When activating or enabling the process for numbering or coding at control unit 6, two fundamental queries to enable the inkjet printhead 1 for printing are initially made in the context of the general printing process.

Sensor 2, as a product sensor, helps determine whether any sheets are even present in the area of the inkjet printhead 1. Another query is made regarding the timing for numbering/coding. This time is determined by sensor 4. Sensor 4 returns a so-called single-rotation signal, which defines a cyclically recurring zero position or starting point for each sheet in relation to the transport position of the sheets. This zero position or starting point can be moved as needed by configuring the sensor 4 relative to the actual machine angle zero position. In practice it is moved so far, that the single-rotation signal is always emitted by sensor 4 when the start of an exposed area of each of the sheets being conveyed in the shingled stream S along the conveyor table 19 lies across from the inkjet printhead 1.

If sensor 2 signals sheets and sensor 4 signals the zero position or starting point, the inkjet printhead 1 is enabled and prints the pattern defined in the control unit on the sheet.

Instead of sensor 4 and detecting the stream position, a sensor 8 may be used for color detection, this sensor can perform an additional disabling function. A provision can be made in the controller that, when certain colors of a sheet are detected, no numbering/coding or a differentiated other coding is to take place, or that coding should, for example, take place only on white sheets. In its effect, the disabling function corresponds to the function of sensor 2 that detects the presence of sheets.

Functionally, this corresponds to a behavior according to which, for color detection, sensor 8 simulates the absence of sheets and thus prevents printing by inkjet printhead 1.

When printing with inkjet printhead 1, a speed adjustment is additionally made, which ensures that a good printed image is always created by the inkjet printhead 1 when the conveying speed of the shingled stream S changes. For this reason, the signal of the rotary encoder 3 for the speed of the conveyor belts 9 is connected directly to the printhead control unit 6 and processed there.

Lastly, the activation of the inkjet printhead 1 from the discharging mechanism 14 of the sheet-fed press 10 is also possible. Therefore, once all machine functions have been ensured and the set-up of the printing process has been completed, if desired and as a basic principle, the printer can activate the numbering/coding function at an on/off switch 7 on the control panel of the discharging mechanism 14.

This kind of activation can, for example, also take place when switching on a good-sheet counter, wherein said counter—possibly in conjunction with a device for sheet inspection 24—registers the production of usable sheets.

With respect to its function, the inventive system can be summarized as follows:

The system for numbering/coding makes it possible that, for internal documentation and the traceability of sheets, every sheet can be individually provided with a numbering or lettering or coding.

For this purpose, an inkjet printhead 1 is incorporated above the conveyor table 19 of a sheet feeding device 11 for a sheet-fed press 10.

The sheets are guided over the conveyor table 19 (e.g. suction belt table) under the inkjet printhead 1 in the usual overlapped manner as a shingled stream S. The inkjet printhead 1 is located in the area in front of the so-called sheet feeder where transfer occurs by means of the pre-gripper 21, and is therefore not subject to the acceleration of the sheets into the first printing unit 12.

The accessible area of one shingle length at the sheet end of every sheet can thus be labeled individually.

The inkjet printhead 1 can also be positioned in a variable format manner. In principle this is necessary only in one direction, transverse to the sheet transport direction R in the sheet plane, because in sheet transport direction R, in terms of signaling, any format length-dependent area can be actuated for printing by the inkjet printhead 1.

The positioning of the inkjet printhead 1 transverse to the sheet running direction R and parallel to the sheet plane can be carried out manually or automatically.

The automated positioning is performed by means of an actuating drive, which is activated on the basis of sheet width-related data acquired or scanned into the machine control when configuring the order.

The positioning can also be coupled to the configuration of the position of a sidelay, wherein the latter is assigned to the sheet side edges of the sheets and disposed in the sheet feeding device 11 and/or in a feedboard 22 disposed there.

In conjunction with a system for sheet inspection 24, the printed sheet number can be displayed on an inspection error log. Thus every defective sheet can later be separated out of the stack.

In terms of the speed and the resolution of inkjet printhead 1, it can in general be noted that high speeds are permissible and achievable for sheet-fed presses. A higher resolution of inkjet printing is possible at slower speeds, however, allowing better print quality to be achieved.

Static and variable data are suitable as printed objects to be processed with the system. Date specifications, times, sheet counts, barcodes or 2D codes, for example, can be printed. However, any other type of coding is possible as well.

As a rule, printing is monochrome and the printing inks used must be matched to the printing substrate. The printing ink is held in cartridges and inserted into the inkjet printhead 1.

The actuation of the inkjet printhead 1 to initiate printing of the coding or numbering can take place based on the activation of a good-sheet counter, by manual operation, after a predetermined production schedule or by automatic actuation after a monitored passage of a number of make-ready sheets.

The activation to control the printing process must also be conditional on the inkjet printhead 1 being in a printing position assigned to the conveyor table 19. Only in the printing position can the functionality of sensors 2 and 8 be used effectively for the control of printing by the inkjet printhead 1.

The printing position of the inkjet printhead 1 can therefore be detected with a position detection sensor system on a pivoting arm 27 or the cross member 26 (see FIG. 2), or on the inkjet printhead 1 itself. If one of the sensors 2, 8 is disposed in the sheet feeder 20 in mechanical coupling together with the inkjet printhead 1, the printing position can be determined via sensors 2 and/or 8 as well.

The layout of the numbering/coding that is to be printed on the sheets can be prepared in the most simple manner on any PC, or even directly at the control unit 6 of the inkjet printhead 1.

If the format of the sheets is modified after an order change, the inkjet printhead 1 has to be positioned in the sheet plane transverse to the sheet transport direction R on areas of the shingled stream S that are to be printed. This initially can be performed manually, by providing the inkjet printhead 1 on a cross member, or also in an automatically controllable manner with appropriate devices for detecting sheet position and sheet format, as already mentioned above.

The position of the zero signal or the start signal must be reset with respect to the position of the numbering/coding in relation to the format length. This configuration is performed by adjusting the signal location of sensor 4 to the beginning of the exposed surface of each sheet in the shingled stream S, which results from the reference to the change of the format length. This configuration can be automated as well, because the data required for the sheet size, sheet position and position of the numbering/coding on the sheet is known before printing begins.

A device for reading database contents can be provided as a further option. The type, content and location of the numbering/coding relating to specific products can be stored in a database. This data can then be transmitted to a sheet-fed press 10 with an inkjet printhead 1 above a conveyor table 19 of the sheet feeding device 11 and used there for the configuration.

This also includes process-related information regarding the alignment of the inkjet printhead 1 with the printing substrate as a function of its thickness. The configurations related to the printing ink can furthermore be considered here, which in terms of the type and amount of ink can be affected as a function of the printing substrate.

In its disposition relative to the shingled stream S of the sheets, the inkjet printhead 1 can be configured in such a way that it is placed on the sheet surface on a sliding element in the form of a carriage member. A constant distance of the inkjet printhead 1 to the surface of the sheets is thus achieved.

Since the transport speed of the sheets can change when conveying the sheets across the conveyor table 19 to the sheet-fed press, at least one characteristic curve, which is configured as a function of parameters of the printing substrate, such as grammage and/or fiber direction and/or stiffness of the sheets, can preferably be stored in the control unit 6 of the inkjet printhead 1. The inkjet printhead 1 is then controlled on the basis of these characteristic curves. The characteristic curves for sheets of different printing substrates are determined in advance.

Several inkjet printheads 1 that are arranged side by side viewed transverse to the transport direction of the sheets, as well as several inkjet printheads 1 that are arranged in a row viewed in the transport direction of the sheets, which are assigned to one another in an array- or matrix-like manner and preferably interconnected on the control side, can be integrated into the sheet-fed press 10.

The number of inkjet printheads 1 required transverse to the direction of printing is primarily defined by the desired total print width in relation to the given printing width of each of the used inkjet printheads 1.

The required number of inkjet heads 1 in sheet transport direction R of the sheets, however, is determined by the fact that the desired printing speed is greater than the given maximum printing speed of one individual inkjet printhead 1, and that multiple inks are to be applied to the sheets with the aid of the inkjet printheads 1. The number of inkjet printheads 1 in sheet transport direction R of the sheet is further defined by the desired print resolution in relation to the given print resolution of each individual inkjet printhead 1 used.

According to an advantageous further embodiment of the present invention, the or every inkjet printhead 1 is removable from the sheet-fed press, in such a way that each inkjet printhead 1 can be used on another sheet-fed press or at a variety of installation positions within the same sheet-fed press. For this purpose, each inkjet printhead 1 has a supply side (namely mechanical, i.e. ink-side) and a control side (namely electric or electronic, interface) via which each inkjet head 1 can be connected to an ink supply system and/or a control system of the respective sheet-fed press.

Viewed in the transport direction of the sheets, a drying device or a curing device and/or a suction device can preferably be disposed downstream of the form-free printing device, wherein the drying device is used for drying the ink applied via the inkjet printhead 1 and the suction device is used to suction off solvent vapors from the ink applied via the inkjet printhead

A camera 25, which is directed onto the sheets, on the print area downstream of the inkjet printhead 1 and previously coated by the inkjet printhead 1, may be connected to the inkjet printhead 1 as well. In this way, by means of the camera 25, the printed coding or numbering can be detected and identified. This ensures that every sheet to be processed is numbered or coded and that there are no gaps in the numbering or coding and that no duplicate numbering or coding is present in the successively to be processed sheets.

The inkjet printhead 1 is mounted in a pivotable manner in the area of the sheet feeder 20 or the conveyor table 19, preferably on the swinging arm 27, which engages directly or via a cross member 28 on a side frame of the sheet feeder 20 or the first of the printing units 12. The conveyor table 19 and the sheet feeder 20 are thereby freely accessible for set-up work, and the inkjet printhead 1 can easily be moved and serviced.

As shown in FIG. 3, an inkjet printhead 1′ can also be arranged across from an underside U of the conveyor table 19. The inkjet printhead 1′ is then directed onto each respective sheet start of the successive sheets in the shingled stream S, because, with the underlapping, the sheet start of a following sheet lies under the sheet end of the preceding sheet. One or more openings 28 are then provided in the conveyor table 19 for printing the coding or numbering of the sheets by means of the inkjet printhead 1′. In this area of the conveyor table 19, the respective front sheet end of the sheets rests in a relatively flat manner on the conveyor table 19 to the side of the suction belts 9 conveying the sheets, and can be printed by the inkjet printhead(s) 1 without any further guidance devices. To prevent soiling of the coding or numbering, it is immediately dried or guided over a conveyor track 29 that allows drying without smearing the print patterns.

The detection of the sheet position, required here as well to control a timely coding or numbering process by the inkjet printhead(s) 1, is performed in the same way as the detection in the design variants for printing from the upper side 0 of the shingled stream S on the conveyor table 19.

### LIST OF REFERENCE SYMBOLS

1 Inkjet printhead, laser printing device

(printing device without a printing form)
2 Sensor/product sensor

(reflected light sensor, laser sensor, color sensor)
2 Rotary encoder

(Measuring wheel with bracket on conveyor belt)
4 Sensor for triggering printing
5 Input/output connection element

(control cabinet first printing unit)
6 Control unit/printhead controller
7 Actuation inkjet printhead from the location of the discharging mechanism; on/off switch
8 Sensor color detection

(to the sheet)
9 Conveyor belt

(designed as a suction belt)
10 Sheet-fed press
11 Sheet feeding device
12 Printing units
13 Coating unit
14 Discharging mechanism
15 Discharger stack
16 Turning cylinder
17 Installation position
18 Installation position
19 Conveyor table

(design here as a suction belt table)
20 Sheet feeder
21 Pre-gripper
22 Feedboard
23 Sheet singling device
24 Sheet inspection
25 Camera

(sheet inspection for inkjet printhead only)
26 Cross member
27 Swinging arm
28 Opening
29 Conveyor track
R Sheet running direction
S Shingled stream of sheets
O Upper side
U Under side

1-11. (canceled)

12. A sheet-fed printing press comprising:
a sheet feeding device for introducing sheets that are to be printed into the sheet-fed printing press, the sheet feeding device including a conveyor configured to transport a shingled stream of sheets;
a printing unit for printing the sheets with a static printed image that is identical for all sheets;
a discharging mechanism for discharging printed sheets from the sheet-fed press; and
a printing device without a printing form that is integrated into the sheet-fed press for printing the sheets with a static printed image or with a printed image that varies from sheet to sheet, the printing device being arrangeable at a plurality of positions in an area of the sheet feeding device;
wherein the printing device is disposed facing an upper side of the convey or table and has an effective printing surface assigned to a top area of the sheets in the shingled stream on the conveyor table.

13. The sheet-fed printing press of claim 12 further including a printing device control system that is configured to store a characteristic curve that is a function of a parameter of the sheet, the printing device control system being operable to control the printing device on the basis of the characteristic curve, wherein the printing device controller is in communication with a sheet-fed printing press control system.

14. The sheet-fed printing press of claim 12 wherein the printing device is configured as an inkjet printhead or a laser printing device, wherein the inkjet printhead or the laser printing device is arranged to print the sheets in the shingled stream (S) across an entire exposed format width or an entire exposed format length of the sheets.

15. The sheet-fed printing press of claim 14 wherein the printing device comprises a plurality of controllably interconnected inkjet printheads or laser printing devices that are arranged side by side viewed transverse to a transport direction of the sheets.

16. The sheet-fed printing press of claim 14 wherein the printing device comprises a plurality of controllably interconnected inkjet printheads or laser printing devices that are arranged in a row viewed in a transport direction of the sheets.

17. The sheet-fed press of claim 12 wherein the printing device is removably mounted in the area of the sheet feeding device.

18. The sheet-fed printing press of claim 12 further including a drying device disposed in a downstream direction from the printing device viewed in a transport direction of the sheets.

19. The sheet-fed printing press according to claim 12 wherein the printing is arranged and configured to be pivotable with respect to the conveyor table.

20. A sheet-fed printing press comprising:
a sheet feeding device for introducing sheets that are to be printed into the sheet-fed printing press, the sheet feeding device including a conveyor configured to transport a shingled stream of sheets;
a printing unit for printing the sheets with a static printed image that is identical for all sheets;
a discharging mechanism for discharging printed sheets from the sheet-fed press; and
a printing device without a printing form that is integrated into the sheet-fed press for printing the sheets with a static printed image or with a printed image that varies from sheet to sheet, the printing device being arrangeable at a plurality of different positions in an area of the sheet feeding device;
wherein the printing device is disposed facing an underside of the conveyor table and has an effective printing surface to a bottom area of the sheets in the shingled stream on the conveyor table.

21. The sheet fed printing press of claim 20 further including a printing device control system that is configured to store a characteristic curve that is a function of a parameter of the sheet, the printing device control system being operable to control the printing device on the basis of the characteristic curve, wherein the printing device controller is in communication with a sheet-fed printing press control system.

22. The sheet-fed printing press of claim 20 wherein the printing device is configured as an inkjet printhead or a laser printing device, wherein the inkjet printhead or the laser printing device is arranged to print the sheets in the shingled stream across an entire exposed format width or an entire exposed format length of the sheets.

23. The sheet-fed printing press of claim 22 wherein the printing device is assigned to at least a partial area of openings in the conveyor table which expose the underside of the sheets resting on the conveyor table.

24. The sheet-fed printing press of claim 22 wherein the printing device comprises a plurality of controllably interconnected inkjet printheads or laser printing devices that are arranged side by side viewed transverse to a transport direction of the sheets.

25. The sheet-fed printing press of claim 22 wherein the printing device comprises a plurality of controllably interconnected inkjet printheads or laser printing devices that are arranged in a row viewed in a transport direction of the sheets.

26. The sheet-fed press of claim 20 wherein the printing device is removably mounted in the area of the sheet feeding device.

27. The sheet-fed printing press of claim 20 further including a drying device disposed in a downstream direction from the printing device viewed in a transport direction of the sheets.

28. The sheet-fed printing press according to claim 12 wherein the printing is arranged and configured to be pivotable with respect to the conveyor table.

29. A sheet-fed printing press comprising:
a sheet feeding device for introducing sheets that are to be printed into the sheet-fed printing press, the sheet feeding device including a conveyor configured to transport a shingled stream of sheets;
a printing unit for printing the sheets with a static printed image that is identical for all sheets;
a discharging mechanism for discharging printed sheets from the sheet-fed press;
a printing device without a printing form that is integrated into the sheet-fed press for printing the sheets with a static printed image or with a printed image that varies from sheet to sheet, the printing device being arrangeable at a plurality of different positions in an area of the sheet feeding device, wherein the printing device is disposed in a stream feeder processing the shingled stream of sheets above an upper side or below an underside of the conveyor table; and
a control system connected to a first sensor for detecting at least one the presence of sheets or a color of sheets across from the printing device and a second sensor for detecting a time of production for activation of the printing device.

30. The sheet-fed printing press of claim 29 wherein the control system is configured to store a characteristic curve that is a function of a parameter of the sheet and is operable to control the printing device on the basis of the characteristic curve, wherein the printing device controller be in communication with a sheet-fed printing press control system.

31. The sheet-fed printing press of claim 29 wherein the printing device is configured as an inkjet printhead or a laser printing device, wherein the inkjet printhead or the laser printing device is arranged to print the sheets in the shingled stream across an entire exposed format width or an entire exposed format length of the sheets.

32. The sheet-fed printing press of claim 31 wherein the printing device comprises a plurality of controllably interconnected inkjet printheads or laser printing devices that are arranged side by side viewed transverse to a transport direction of the sheets.

33. The sheet-fed printing press of claim 31 wherein the printing device comprises a plurality of controllably interconnected inkjet printheads or laser printing devices that are arranged in a row viewed in a transport direction of the sheets.

34. The sheet-fed press of claim 29 wherein the printing device is removably mounted in the area of the sheet feeding device.

35. The sheet-fed printing press of claim 29 further including drying device disposed in a downstream direction from the printing device viewed in a transport direction of the sheets.

36. The sheet-fed printing press according to claim 29 wherein the printing is arranged and configured to be pivotable with respect to the conveyor table.

37. A method for operating a sheet-fed printing press, the sheet-fed printing press having a sheet feeding device for introducing sheets that are to be printed into the sheet-fed press, a printing unit for printing the sheets with a static printed image that is identical for all sheets, a discharging mechanism for discharging printed sheets from the sheet-fed press, and a printing device without a printing form that is integrated into the sheet-fed press for printing the sheets with a static printed image or with a printed image that varies from sheet to sheet, the method comprising the steps of:
activating the printing device for production; and
enabling the printing device only once a first sensor signals at least one the presence of sheets or a color of sheets in a print area and when a second sensor signals a starting position or starting time for passage of each of the sheets, wherein the starting position or starting time is adjustable as a function of a print format length of the print format.
